(19) United States
(12) Patent Application Publication
(10) Pub. No.: US 2026/0260892 A1
(43) Pub. Date: Sep. 3, 2026

(54) CARBON NANOPOROUS FRAMEWORK PREPARED THROUGH SUPERCRITICAL FLUID-ASSISTED IN-SITU POLYMERIZATION, AND METHOD

(71) Applicants: SHENZHEN FAYMO TECHNOLOGY CO., LTD., Shenzhen, Guangdong (CN); QUJING FAYMO TECHNOLOGY CO., LTD., Yunnan (CN)

(72) Inventors: Xinda LI, Shenzhen, Guangdong (CN); Shaozhen HUANG, Shenzhen, Guangdong (CN); Ji ZHANG, Shenzhen, Guangdong (CN); Dongfeng WANG, Shenzhen, Guangdong (CN); Lingyong KONG, Shenzhen, Guangdong (CN)

(21) Appl. No.: 18/839,575

(22) PCT Filed: Apr. 12, 2023
(86) PCT No.: PCT/CN2023/087830

§ 371 Date: Aug. 19, 2024

(30) Foreign Application Priority Data
Mar. 23, 2023 (CN) 202310289196.X

(51) Int. Cl. H01M 4/62; C08G 65/08; C08J 3/21; C08K 3/04; H01G 11/36

(52) U.S. Cl. CPC H01M 4/625; C08G 65/08; C08J 3/212; C08K 3/041; H01G 11/36; C08J 2371/02; C08K 2201/001; C08K 2201/006; C08K 2201/011

(57) ABSTRACT

Disclosed is a carbon nanoporous framework prepared through supercritical fluid-assisted in-situ polymerization, and a method. The method for preparing a carbon nanoporous framework through supercritical fluid-assisted in-situ polymerization includes the following steps: mixing a carbon nanomaterial, a strong alkali reagent, an epoxy monomer, and a supercritical fluid solvent in a reactor until the strong alkali reagent fully reacts with the epoxy monomer, where a reaction pressure and a reaction temperature in the reactor are controlled to keep the supercritical fluid solvent in a supercritical fluid state; and rapidly releasing a pressure in the reactor until the pressure in the reactor is one standard atmosphere, and taking a product in the reactor out to obtain the carbon nanoporous framework. The strong alkali reagent is soluble in an organic solvent.

### CROSS REFERENCE TO RELATED APPLICATION

This application is a U.S. national phase of International Patent Application No. PCT/CN2023/087830 with an international filing date of Apr. 12, 2023, designating the U.S., now pending, and further claims priority to the Chinese Patent Application 202310289196.X filed with the Chinese Patent Office on Mar. 23, 2023 and titled “CARBON NANOPOROUS FRAMEWORK PREPARED THROUGH SUPERCRITICAL FLUID-ASSISTED IN-SITU POLYMERIZATION, AND METHOD”, the contents each of which are incorporated herein by reference in their entirety.

### TECHNICAL FIELD

The present disclosure relates to the technical field of materials, and in particular to a carbon nanoporous framework prepared through supercritical fluid-assisted in-situ polymerization, and a method.

### BACKGROUND

Carbon nanomaterials refer to carbon materials in which a size of a dispersed phase in at least one dimension is less than 100 nm. Carbon nanomaterials mainly include the following three types: carbon nanotubes, carbon nanofibers, and carbon nanocapsules. Among carbon nanomaterials, the novel carbon materials of carbon nanofibers and carbon nanotubes have many excellent physical and chemical properties and are widely used in many fields.

However, carbon nanotubes prepared by the current preparation method are in a form of agglomerates. The agglomeration of carbon nanotubes seriously affects the electrical and mechanical properties of carbon nanotubes, and agglomerated carbon nanotubes cannot be directly applied to the market. Therefore, agglomerated carbon nanotubes need to be dispersed before use.

In the prior art, the dispersion method for carbon nanotubes is mainly as follows: carbon nanotubes, polyvinylpyrrolidone (PVP) as a dispersing agent, and N-methylpyrrolidone (NMP) or water as a solvent are mixed in a specified ratio, and then carbon nanotubes are cut in the solvent by a high-speed dispersing machine or a ball mill, such that truncated carbon nanotubes are produced and surfaces of carbon nanotubes are bonded with the dispersing agent, which can avoid the agglomeration.

The above technical proposal has the following problems: 1. Carbon nanotubes are cut during physical ball-milling, which affects the length-to-diameter ratios and physical and chemical properties of carbon nanotubes. 2. The dispersing agent adopted is a polymer dispersing agent, and the polymer dispersing agent is difficult to completely enter gaps among agglomerated carbon nanotubes, resulting in a limited dispersion effect. Therefore, the existing carbon nanotubes are difficult to disperse, which affects the exertion of properties of carbon nanotubes.

### SUMMARY

A first objective of the present disclosure is to provide a carbon nanoporous framework. When the carbon nanoporous framework is placed in a solvent, carbon nanomaterials can be uniformly dispersed through simple stirring, which solves the problem that it is difficult to disperse carbon nanomaterials.

A second objective of the present disclosure is to provide a method for preparing a carbon nanoporous framework through supercritical fluid-assisted in-situ polymerization. The preparation of a carbon nanoporous framework by this method can solve the problem that it is difficult to disperse carbon nanomaterials.

In order to solve the above technical problems, the present disclosure adopts the following technical proposals:

A carbon nanoporous framework is provided, including a plurality of carbon nanounits, where surfaces of the plurality of carbon nanounits are connected to form a three-dimensional network framework, there is a gap between adjacent carbon nanounits, the plurality of carbon nanounits each include a carbon nanomaterial and a polymer evenly wrapped around a surface of the carbon nanomaterial, and adjacent carbon nanounits are interconnected by the polymer.

A method for preparing a carbon nanoporous framework through supercritical fluid-assisted in-situ polymerization is provided, including the following steps:
mixing a carbon nanomaterial, a strong alkali reagent, an epoxy monomer, and a supercritical fluid solvent in a reactor until the strong alkali reagent fully reacts with the epoxy monomer, where a reaction pressure and a reaction temperature in the reactor are controlled to keep the supercritical fluid solvent in a supercritical fluid state; and rapidly releasing a pressure in the reactor until the pressure in the reactor is one standard atmosphere, and taking a product in the reactor out to obtain the carbon nanoporous framework. The strong alkali reagent is soluble in an organic solvent.

The substances are added as follows:
the carbon nanomaterial is first mixed with the supercritical fluid solvent in the reactor, then the strong alkali reagent is added to allow a first reaction, and then the epoxy monomer is added to allow a second reaction.

The carbon nanomaterial, the strong alkali reagent, the epoxy monomer, and the supercritical fluid solvent are in a mass ratio of (5-15):(0.05-0.2):(1-3):(5-15).

The strong alkali reagent includes at least one selected from the group consisting of sodium ethoxide, potassium ethoxide, sodium hydroxide, and potassium hydroxide.

The epoxy monomer includes at least one selected from the group consisting of propylene oxide, ethylene oxide, and butylene oxide.

The supercritical fluid solvent includes at least one selected from the group consisting of a supercritical carbon dioxide solvent, a supercritical ethanol solvent, and a supercritical propanol solvent.

The carbon nanomaterial includes at least one selected from the group consisting of a single-walled carbon nanotube, a multi-walled carbon nanotube, and graphene.

The method further includes: introducing an organic co-solvent into the reactor for mixing with the carbon nanomaterial, the strong alkali reagent, the epoxy monomer, and the supercritical fluid solvent.

In the reactor, the reaction pressure is controlled at 7 MPa to 25 MPa and the reaction temperature is controlled at 80° C. to 100° C. After the substances in the reactor react for 3 hrs to 5 hrs, the pressure in the reactor is released.

The carbon nanoporous framework of the present disclosure solves the problem that it is difficult to disperse carbon nanomaterials. When in use, the carbon nanoporous framework is placed in a solvent, and carbon nanomaterials can be uniformly dispersed through simple mechanical stirring with a prominent dispersion effect, which does not require the addition of an additional dispersing agent and also does not require the shearing or grinding of carbon nanomaterials by a high-speed dispersing machine or a ball mill. The above dispersion method is simple, can retain the original high length-to-diameter ratio and the excellent electric conductivity of a carbon nanomaterial, and can improve an electric conduction effect of a dispersion. The carbon nanoporous framework can be used in a lithium electrode, a supercapacitor electrode, a polymer composite, or the like.

The carbon nanoporous framework in the present disclosure has a density of 0.01 g/cm³ to 0.3 g/cm³, a specific surface area of 100 m²/g to 400 m²/g, and a porosity of 50% to 98%.

### BRIEF DESCRIPTION OF THE DRAWINGS

To describe the technical proposals in the embodiments of the present disclosure clearly, the accompanying drawings required for describing the embodiments or the prior art are described briefly below. Apparently, the accompanying drawings in the following description merely show some embodiments of the present disclosure, and those of ordinary skill in the art may still derive other accompanying drawings from these accompanying drawings without creative efforts.

FIG. 1 shows scanning electron microscopy (SEM) images of a carbon nanotube porous framework prepared by the method of the present disclosure;

FIG. 2 shows SEM images of a graphene porous framework prepared by the method of the present disclosure;

FIG. 3 shows SEM images of a lithium iron phosphate positive electrode sheet fabricated with the carbon nanoporous framework of the present disclosure; and

FIG. 4 shows an SEM image of a conductive plastic fabricated with the carbon nanoporous framework of the present disclosure.

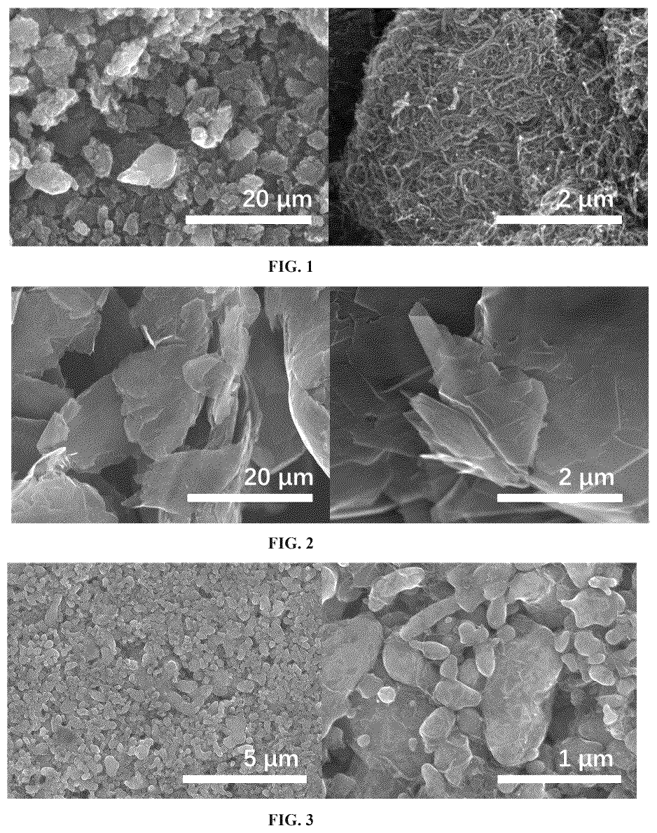

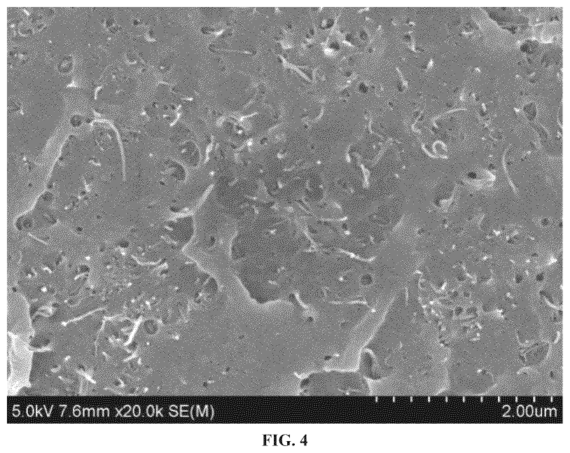

### DETAILED DESCRIPTION OF THE EMBODIMENTS

In order to make the objectives, technical proposals, and technical effects of the embodiments of the present disclosure clear, the technical proposals in the embodiments of the present disclosure are described clearly and completely below. Apparently, the described embodiments are some rather than all of the embodiments of the present disclosure. In conjunction with the embodiments of the present disclosure, all other embodiments obtained by those of ordinary skill in the art without creative efforts fall within the protection scope of the present disclosure. If no specific conditions are specified in the embodiments, the embodiments will be implemented under conventional conditions or conditions recommended by a manufacturer. All of the reagents or instruments which are not specified with manufacturers are conventional commercially-available products.

In the description of the present disclosure, the term “and/or” describes an association relationship between associated objects, and indicates three types of relationships. For example, “A and/or B” may indicate that A exists alone, A and B coexist, or B exists alone. “A” and “B” each may be singular or plural. The character “/” usually indicates an “or” relationship between associated objects.

In the description of the present disclosure, the term “at least one” refers to one or more, and the term “a plurality of” refers to two or more. The term “at least one of the following items” or a similar expression refers to any combination of these items, including a single item or any combination of a plurality of items. For example, both “at least one of a, b, or c” and “at least one of a, b, and c” can indicate: a, b, c, a-b (namely, a and b), a-c, b-c, or a-b-c, where a, b, and c may each be a singular or plural item.

It should be understood that the weights of related components mentioned in the embodiments of the present disclosure may not only refer to a specific content of each component, but also indicate a proportional relationship between the weights of components. Therefore, as long as the contents of related components are scaled up or down according to the embodiments of the present disclosure, results are within the scope disclosed in the present disclosure. Specifically, the weights mentioned in the embodiments of the present disclosure may be expressed in mass units well known in the chemical industry, such as μg, mg, g, and kg.

In addition, unless otherwise clearly indicated in the context, the expression of a singular form of a word shall be understood as including a plural form of the word. The term “including” or “having” is intended to specify the existence of a feature, a quantity, a step, an operation, a component, a part, or a combination thereof, but is not intended to exclude the existence or possible addition of one or more other features, quantities, steps, operations, components, parts, or combinations thereof.

An embodiment of the present disclosure provides a carbon nanoporous framework, including a plurality of carbon nanounits, where surfaces of the plurality of carbon nanounits are connected to form a three-dimensional network framework, there is a gap between adjacent carbon nanounits, the plurality of carbon nanounits each include a carbon nanomaterial and a polymer evenly wrapped around a surface of the carbon nanomaterial, and adjacent carbon nanounits are interconnected by the polymer.

The carbon nanoporous framework of the present disclosure is a three-dimensional network framework formed through the interconnection of a plurality of carbon nanounits. Surfaces of carbon nanomaterials are wrapped by the polymer, such that the carbon nanomaterials are isolated from each other and cannot undergo agglomeration. In addition, a gap is left between adjacent carbon nanounits to form a porous and breakable structure. When the carbon nanoporous framework is added to a solvent, the porous structure facilitates the solvent to enter gaps among carbon nanounits, such that the carbon nanounits can be dissolved, which is conducive to the dispersion of carbon nanomaterials. Moreover, due to the porous and breakable structure, the carbon nanounits can be separated merely under an action of simple mechanical stirring to allow the uniform dispersion of carbon nanomaterials, and the dispersed carbon nanomaterials will not undergo agglomeration once again.

In summary, the carbon nanoporous framework of the present disclosure solves the problem that it is difficult to disperse carbon nanomaterials. When in use, the carbon nanoporous framework is placed in a solvent, and carbon nanomaterials can be uniformly dispersed through simple mechanical stirring with a prominent dispersion effect, which does not require the addition of an additional dispersing agent and also does not require the shearing or grinding of carbon nanomaterials by a high-speed dispersing machine or a ball mill. The above dispersion method is simple, can retain the original high length-to-diameter ratio and the excellent electric conductivity of a carbon nanomaterial, and can improve an electric conduction effect of a dispersion.

The carbon nanoporous framework can be used in a lithium electrode, a supercapacitor electrode, a polymer composite, or the like.

The carbon nanomaterial includes at least one selected from the group consisting of a single-walled carbon nanotube, a multi-walled carbon nanotube, and graphene. The polymer is an epoxy polymer. The epoxy polymer is soluble in an organic solvent and has excellent solubility in the NMP solvent. As a result, when the carbon nanoporous framework is placed in the NMP solvent, carbon nanomaterials can be dispersed through simple stirring, which does not require the addition of an additional dispersing agent and also does not require the shearing or grinding of carbon nanomaterials by a high-speed dispersing machine or a ball mill. The above dispersion method is simple, can retain the original high length-to-diameter ratio and the excellent electric conductivity of a carbon nanomaterial dispersed, and can improve an electric conduction effect of a dispersion.

Specifically, the polymer is at least one selected from the group consisting of polypropylene oxide, ethylene oxide-propylene oxide copolyether, and polyethylene oxide.

In the carbon nanoporous framework, a ratio of a total mass of the plurality of carbon nanounits to a mass of the polymer can be (5-15):(1-3), namely, 5:3 to 15:1.

A method for preparing the carbon nanoporous framework through supercritical fluid-assisted in-situ polymerization is provided, including the following steps:
a carbon nanomaterial, a strong alkali reagent, an epoxy monomer, and a supercritical fluid solvent are mixed in a reactor until the strong alkali reagent fully reacts with the epoxy monomer, where a reaction pressure and a reaction temperature in the reactor are controlled to keep the supercritical fluid solvent in a supercritical fluid state; and a pressure in the reactor is rapidly released until the pressure in the reactor is one standard atmosphere, and a product in the reactor is taken out to obtain the carbon nanoporous framework. The strong alkali reagent is soluble in an organic solvent.

In the present disclosure, the carbon nanoporous framework is prepared through supercritical fluid-assisted in-situ polymerization. The prepared carbon nanoporous framework solves the technical problem that it is difficult to disperse carbon nanomaterials. To disperse the carbon nanoporous framework prepared by the method of the present disclosure, the carbon nanoporous framework only needs to be placed in a solvent such as NMP, and then simple low-speed stirring is conducted to allow the uniform dispersion of the carbon nanomaterial, which can allow the dispersion performance allowed only by the traditional carbon nanomaterial dispersion process.

Specifically, in the present disclosure, the carbon nanomaterial, the strong alkali reagent, the epoxy monomer, and the supercritical fluid solvent are mixed, during which a reaction pressure and a reaction temperature are controlled to keep the supercritical fluid solvent in a supercritical fluid state. Because the supercritical fluid solvent has a smaller surface energy than other solvents, the supercritical fluid solvent can enter the gaps among the agglomerated carbon nanomaterials and can dissolve the strong alkali reagent and the epoxy monomer. Because the strong alkali reagent and the epoxy monomer both are substances with small molecular weights, the strong alkali reagent and the epoxy monomer can be brought into the gaps among the agglomerated carbon nanomaterials by a supercritical fluid when mixed with the supercritical fluid solvent. The strong alkali reagent, as a deagglomeration agent for agglomerated carbon nanomaterials, can preliminarily disperse the entangled carbon nanomaterials, and can increase the gaps among carbon nanomaterials such that reactants such as the strong alkali reagent and the epoxy monomer can easily enter the gaps among carbon nanomaterials. The strong alkali reagent, as a catalyst, can catalyze the polymerization of the epoxy monomer located in the gaps among carbon nanomaterials to generate an epoxy polymer. The generated epoxy polymer is wrapped around a surface of a carbon nanomaterial to produce a steric hindrance among carbon nanomaterials, such that the carbon nanomaterials are completely dispersed. After a reaction is completed, a pressure in the reactor is rapidly released until the pressure in the reactor is one standard atmosphere. During the instantaneous pressure release, the supercritical fluid solvent returns to a conventional phase state, becomes a gas or liquid, and is discharged from the inside of the carbon nanomaterial to obtain a carbon nanoporous framework product including the carbon nanomaterial, the epoxy polymer, and a small amount of the strong alkali reagent.

Specifically, when the supercritical fluid solvent undergoes a phase transformation and is rapidly discharged from the inside of the product due to the rapid pressure release, a large number of pores are left in the product, such that the product expands. The gaps among carbon nanomaterials are increased due to the existence of the large number of pores. The large number of pores make epoxy polymers wrapped around surfaces of adjacent carbon nanomaterials isolated from each other, and reduce a connection area between epoxy polymers of adjacent carbon nanounits, such that the carbon nanoporous framework formed is breakable. The carbon nanoporous framework can be added to a solvent, and carbon nanomaterials on the carbon nanoporous framework can be dispersed through simple mechanical stirring to obtain a homogeneous dispersion, which does not require the addition of an additional dispersing agent and the high-speed shearing or grinding. Compared with the grinding and high-speed shearing, the low-speed mechanical stirring can retain the original length-to-diameter ratio of a carbon nanomaterial, and can improve the electric conductivity of a dispersion.

In the present disclosure, the polymer is not directly mixed with the carbon nanomaterial and the supercritical fluid solvent, but the strong alkali reagent and the epoxy monomer that are small molecules are adopted because the polymer has a large molecular weight and is difficult to completely enter the gaps among the agglomerated carbon nanomaterials to allow the complete dispersion of carbon nanomaterials. In the present disclosure, the small-molecule reagents can well enter the gaps among the agglomerated carbon nanomaterials under an action of the supercritical fluid solvent to be dispersed among the carbon nanomaterials, and the strong alkali reagent is used to deagglomerate the entangled carbon nanomaterials to make the entangled carbon nanomaterials initially dispersed and increase the gaps among the carbon nanomaterials, which facilitates the epoxy monomer to enter the gaps among the agglomerated carbon nanomaterials. As a result, the epoxy monomer undergoes polymerization in the gaps among the agglomerated carbon nanomaterials under a catalytic action of the strong alkali reagent to produce a polymer steric hindrance, and adjacent carbon nanomaterials are separated. The preparation method of the present disclosure is conducive to improving the dispersion performance of carbon nanomaterials. Specifically, the carbon nanomaterial is a carbon nanotube or graphene.

The substances are added as follows:
the carbon nanomaterial is first mixed with the supercritical fluid solvent in the reactor, then the strong alkali reagent is added to allow a first reaction, and then the epoxy monomer is added to allow a second reaction.

In the present disclosure, the carbon nanomaterial and the supercritical fluid solvent are first mixed, such that the carbon nanomaterial can be preliminarily dispersed with the supercritical fluid solvent, which facilitates the reaction reagents to enter the gaps among carbon nanomaterials. Then, the strong alkali reagent is added. The strong alkali reagent, as a deagglomeration agent, can be brought into the gaps among carbon nanomaterials under an action of the supercritical fluid solvent to deagglomerate the carbon nanomaterials and increase the gaps among carbon nanomaterials, such that the epoxy monomer can enter the gaps among carbon nanomaterials rapidly and uniformly. Finally, the epoxy monomer is added. The epoxy monomer is brought into the gaps among carbon nanomaterials under an action of a supercritical fluid to be uniformly dispersed inside the agglomerated carbon nanomaterials. Under a catalytic action of the strong alkali reagent, the epoxy monomer undergoes polymerization to produce the polymer, such that a steric hindrance is generated among the carbon nanomaterials and the carbon nanomaterials are completely dispersed, which is conducive to improving the dispersion performance of carbon nanomaterials.

The carbon nanomaterial, the strong alkali reagent, the epoxy monomer, and the supercritical fluid solvent are in a mass ratio of (5-15):(0.05-0.2):(1-3):(5-15).

A carbon nanoporous framework prepared with the above mass ratio has excellent dispersion performance and high electric conductivity. When an amount of the strong alkali reagent is too low, the strong alkali reagent cannot completely deagglomerate the agglomerated carbon nanomaterials, such that the epoxy monomer cannot be uniformly distributed in the gaps among carbon nanomaterials subsequently, which affects the dispersion of carbon nanomaterials, a synthesis speed of the epoxy polymer, and a preparation efficiency of the product. When the amount of the strong alkali reagent is too high, a large amount of the strong alkali reagent will adhere to the prepared carbon nanoporous framework, which results in many impurities in carbon nanomaterials dispersed and affects the electric conductivity and subsequent use of carbon nanomaterials. When an amount of the epoxy monomer is too low, only a small amount of the epoxy polymer can be generated, and it is impossible to produce a steric hindrance among carbon nanomaterials, which affects the dispersion performance of carbon nanomaterials. When the amount of the epoxy monomer is too high, an excessive amount of the epoxy polymer is generated and wrapped around the surfaces of carbon nanomaterials, which affects the exertion of electric conductivity of carbon nanomaterials. In addition, the excessive amount of the epoxy polymer will make the carbon nanounits in the carbon nanoporous framework firmly bonded, such that, after the carbon nanoporous framework is added to a solvent, the carbon nanoporous framework is difficult to break and the carbon nanounits are difficult to separate under low-speed stirring, which affects the electric conductivity of a dispersion.

The strong alkali reagent includes at least one selected from the group consisting of sodium ethoxide, potassium ethoxide, sodium hydroxide, and potassium hydroxide.

The above types of strong alkali reagents can be dissolved in the supercritical fluid solvent, and the above types of metal ions can be bonded with a bonds of carbon nanomaterials in the supercritical fluid solvent to deagglomerate the agglomerated carbon nanomaterials and catalyze the epoxy monomer, such that the epoxy monomer undergoes polymerization to produce the epoxy polymer and generate a steric hindrance among carbon nanomaterials, which is conducive to improving a dispersion effect of carbon nanomaterials.

The epoxy monomer includes at least one selected from the group consisting of propylene oxide, ethylene oxide, and butylene oxide.

The above types of epoxy monomers can enter the gaps among carbon nanomaterials under an action of the supercritical fluid solvent and rapidly undergo polymerization under a catalytic action of the strong alkali reagent, and a polymerization product produce a steric hindrance among carbon nanomaterials, such that the carbon nanomaterials are dispersed and will not undergo agglomeration once again, which is conducive to improving the dispersion performance and electric conductivity of carbon nanomaterials.

Preferably, the epoxy monomer is a mixed monomer of propylene oxide and ethylene oxide in a mass ratio of 1:1. The mixed monomer of propylene oxide and ethylene oxide can produce an ethylene oxide-propylene oxide copolyether under an action of a catalyst, which is conducive to improving the dispersion performance and electric conductivity of carbon nanomaterials.

The supercritical fluid solvent includes at least one selected from the group consisting of a supercritical carbon dioxide solvent, a supercritical ethanol solvent, and a supercritical propanol solvent.

The above types of supercritical fluid solvents exhibit excellent solubility for the strong alkali reagent and the epoxy monomer, and can bring the strong alkali reagent and the epoxy monomer into the gaps among the agglomerated carbon nanomaterials, such that the strong alkali reagent reacts with the epoxy monomer in the gaps among carbon nanomaterials and a polymerization product produces a steric hindrance among carbon nanomaterials to allow the dispersion of carbon nanomaterials. As a result, there are many pores inside the product produced after the pressure release. The above types of supercritical fluid solvents have a relatively-low supercritical temperature and supercritical pressure, which facilitates a reaction to proceed.

Preferably, the supercritical fluid solvent is a supercritical carbon dioxide solvent. After the instantaneous pressure release, the supercritical carbon dioxide solvent becomes a carbon dioxide gas and is directly discharged with a high discharge efficiency. The carbon nanoporous framework product has a high porosity, which is conducive to improving the dispersion performance of carbon nanomaterials. After being added to a solvent, the prepared carbon nanoporous framework is prone to breakage and dispersion, and a resulting carbon nanomaterial dispersion has high electric conductivity.

The carbon nanomaterial includes at least one selected from the group consisting of a single-walled carbon nanotube, a multi-walled carbon nanotube, and graphene.

The method further includes: an organic co-solvent is introduced into the reactor for mixing with the carbon nanomaterial, the strong alkali reagent, the epoxy monomer, and the supercritical fluid solvent.

The organic co-solvent can improve the solubility of the strong alkali reagent in the supercritical fluid solvent, such that the strong alkali reagent can fully enter the gaps among carbon nanomaterials and is bonded with π bonds on carbon nanomaterials to improve a separation effect among carbon nanomaterials, which promotes the epoxy monomer to enter the gaps among carbon nanomaterials and undergo polymerization to improve the dispersion performance of carbon nanomaterials.

Preferably, the organic co-solvent is methanol, and a mass ratio of the organic co-solvent to the supercritical fluid solvent is (0.5-1):1.

In the reactor, the reaction pressure is controlled at 7 MPa to 25 MPa and the reaction temperature is controlled at 80° C. to 100° C. After the substances in the reactor react for 3 hrs to 5 hrs, the pressure in the reactor is released.

Preferably, when the pressure in the reactor is released, the pressure in the reactor drops to one standard atmosphere within 0.1 s. Through the instantaneous rapid pressure release, the supercritical fluid solvent can instantaneously become a gas with a reduced density and an increased volume to increase the gaps among carbon nanomaterials and rapidly expand the product. The gas is rapidly discharged out of the product under a pressure action, such that many pores are generated inside the product and carbon nanomaterials are evenly dispersed. Due to the porous structure, the product is easily broken in a solvent, and carbon nanomaterials have excellent dispersion performance, high stability, and prominent electric conductivity.

Specifically, the carbon nanoporous framework has a density of 0.01 g/cm³ to 0.3 g/cm³, a specific surface area of 100 m²/g to 400 m²/g, and a porosity of 50% to 98%.

In order to make the above-mentioned implementation details and operations of the present disclosure clearly understood by those skilled in the art and the progressive performance of the embodiments of the present disclosure significantly embodied, the above technical proposals are illustrated below through various examples.

### Example 1

A method for preparing a carbon nanoporous framework through supercritical fluid-assisted in-situ polymerization was provided, including the following steps:
5 parts by weight of a multi-walled carbon nanotube and 5 parts by weight of a supercritical carbon dioxide fluid solvent were mixed and stirred in a reactor. Then 0.05 part by weight of sodium ethoxide was added to the reactor to obtain a first mixed system, and the first mixed system was stirred. Then 5 parts by weight of methanol were added to the reactor to obtain a second mixed system, and the second mixed system was stirred thoroughly. Then 1 part by weight of propylene oxide was added to the reactor to obtain a third mixed system, and the third mixed system was stirred to obtain a fourth mixed system. At a reaction pressure of 10 MPa and a reaction temperature of 80° C. in the reactor, the fourth mixed system was stirred at a stirring speed of 50 r/min to allow a reaction for 3 h. After the reaction was completed, a pressure in the reactor was released within 0.1 s until the pressure in the reactor dropped to one standard atmosphere, and a product in the reactor was taken out to obtain a carbon nanoporous framework, specifically a carbon nanotube porous framework.

### Example 2

A method for preparing a carbon nanoporous framework through supercritical fluid-assisted in-situ polymerization was provided, including the following steps:
10 parts by weight of a multi-walled carbon nanotube and 10 parts by weight of a supercritical carbon dioxide fluid solvent were mixed and stirred in a reactor. Then 0.1 part by weight of sodium ethoxide was added to the reactor to obtain a first mixed system, and the first mixed system was stirred. Then 10 parts by weight of methanol were added to the reactor to obtain a second mixed system, and the second mixed system was stirred thoroughly. Then 2 parts by weight of propylene oxide were added to the reactor to obtain a third mixed system, and the third mixed system was stirred to obtain a fourth mixed system. At a reaction pressure of 16 MPa and a reaction temperature of 90° C. in the reactor, the fourth mixed system was stirred at a stirring speed of 50 r/min to allow a reaction for 4 h. After the reaction was completed, a pressure in the reactor was released within 0.1 s until the pressure in the reactor dropped to one standard atmosphere, and a product in the reactor was taken out to obtain a carbon nanoporous framework, specifically a carbon nanotube porous framework.

### Example 3

A method for preparing a carbon nanoporous framework through supercritical fluid-assisted in-situ polymerization was provided, including the following steps:
15 parts by weight of a multi-walled carbon nanotube and 15 parts by weight of a supercritical carbon dioxide fluid solvent were mixed and stirred in a reactor. Then 0.2 part by weight of sodium ethoxide was added to the reactor to obtain a first mixed system, and the first mixed system was stirred. Then 15 parts by weight of methanol were added to the reactor to obtain a second mixed system, and the second mixed system was stirred thoroughly. Then 3 parts by weight of propylene oxide were added to the reactor to obtain a third mixed system, and the third mixed system was stirred to obtain a fourth mixed system. At a reaction pressure of 25 MPa and a reaction temperature of 100° C. in the reactor, the fourth mixed system was stirred at a stirring speed of 50 r/min to allow a reaction for 5 hrs. After the reaction was completed, a pressure in the reactor was released within 0.1 s until the pressure in the reactor dropped to one standard atmosphere, and a product in the reactor was taken out to obtain a carbon nanoporous framework, specifically a carbon nanotube porous framework.

### Example 4

A method for preparing a carbon nanoporous framework through supercritical fluid-assisted in-situ polymerization was provided, including the following steps:
5 parts by weight of a multi-walled carbon nanotube, 5 parts by weight of a supercritical carbon dioxide fluid solvent, 0.05 part by weight of sodium ethoxide, 5 parts by weight of methanol, and 1 part by weight of propylene oxide were mixed and stirred thoroughly in a reactor to obtain a mixed system. At a reaction pressure of 10 MPa and a reaction temperature of 80° C. in the reactor, the mixed system was stirred at a stirring speed of 50 r/min to allow a reaction for 3 h. After the reaction was completed, a pressure in the reactor was released within 0.1 s until the pressure in the reactor dropped to one standard atmosphere, and a product in the reactor was taken out to obtain a carbon nanoporous framework, specifically a carbon nanotube porous framework.

### Example 5

A method for preparing a carbon nanoporous framework through supercritical fluid-assisted in-situ polymerization was provided. The method in Example 5 was the same as the method in Example 1, except that the carbon nanomaterial in Example 5 was graphene and the carbon nanoporous framework prepared in Example 5 was a graphene porous framework.

### Comparative Example 1

A preparation method of a carbon nanotube porous framework was provided, including the following steps:
5 parts by weight of a multi-walled carbon nanotube and 5 parts by weight of a supercritical carbon dioxide fluid solvent were mixed and stirred in a reactor, and then 1 part by weight of polypropylene oxide was added to the reactor to obtain a mixed system. At a reaction pressure of 10 MPa and a reaction temperature of 80° C. in the reactor, the mixed system was stirred at a stirring speed of 50 r/min to allow a reaction for 3 h. After the reaction was completed, a pressure in the reactor was released within 0.1 s until the pressure in the reactor dropped to one standard atmosphere, and a product in the reactor was taken out to obtain a carbon nanotube porous framework.

### Comparative Example 2

A preparation method of a carbon nanoporous framework was provided. Comparative Example 2 was the same as Comparative Example 1, except that the polypropylene oxide in Comparative Example 1 was replaced with PVP.

### Comparative Example 3

A carbon nanotube dispersion was prepared as follows: 5 parts by weight of a multi-walled carbon nanotube, 1 part by weight of a PVP dispersing agent, and 100 parts by weight of an NMP solvent were mixed to obtain a mixed system, and then the mixed system was subjected to dispersion for 1 h by a high-speed dispersing machine with a dispersion speed of 4,000 rpm to obtain the carbon nanotube dispersion.

### Performance Tests

1. A lithium iron phosphate positive electrode sheet was fabricated and tested for resistivity.

Fabrication method of the lithium iron phosphate positive electrode sheet: According to a specified ratio, a polyvinylidene fluoride (PVDF) binder, a conductive agent, and an NMP solvent were mixed in a barrel and stirred by a dispensing spoon to make the materials mixed thoroughly, and then a lithium iron phosphate cathode material was added to the barrel to obtain a mixed system. The PVDF binder, the conductive agent, the NMP solvent, and the lithium iron phosphate cathode material were in a mass ratio of 2.5:0.8:40:56.7. The mixed system was thoroughly stirred by the dispensing spoon to prevent a dry powder of the cathode material from sticking to a wall, and subjected to dispersion for 1 h at a linear speed of 15 m/s to obtain a slurry. The slurry was coated to form a film, and the film was finally oven-dried and cut into a disc with a diameter of 18 mm to obtain the lithium iron phosphate positive electrode sheet. The resistivity of an electrode sheet sample was determined by a four-point probe testing machine.

With each of the carbon nanoporous materials prepared in Examples 1 to 5 and Comparative Examples 1 and 2 and the carbon nanotube dispersion prepared in Comparative Example 3 as a conductive agent, different lithium iron phosphate positive electrode sheet samples were fabricated according to the above method, and then the resistivity of each electrode sheet sample was tested. Test results were recorded in Table 1.

TABLE 1

| | Example | Example | Example | Example | Example | Comparative | Comparative | Comparative |
|---|---|---|---|---|---|---|---|---|
| Sample | 1 | 2 | 3 | 4 | 5 | Example 1 | Example 2 | Example 3 |
| Resistivity of an | 4.0 | 4.5 | 4.8 | 8.2 | 12.0 | 63.0 | 55.4 | 219.7 |
| electrode sheet with 0.8 | | | | | | | | |
| wt % of a conductive | | | | | | | | |
| agent (Ω · cm) | | | | | | | | |

According to the above test results: When a lithium iron phosphate positive electrode sheet is fabricated with 0.8 wt % of the carbon nanotube porous framework prepared by the method of the present disclosure, the resistivity of the lithium iron phosphate positive electrode sheet can be reduced to 4.0 Ω·cm, indicating that the carbon nanotube porous framework prepared by the method of the present disclosure has excellent dispersion performance and high electric conductivity.

Lithium iron phosphate positive electrode sheets fabricated with the carbon nanotube porous frameworks in Examples 1 and 4 are compared in terms of resistivity, and the lithium iron phosphate positive electrode sheet fabricated with the carbon nanotube porous framework in Example 1 has small resistivity, indicating that the carbon nanotube porous framework in Example 1 exhibits better electric conductivity than the carbon nanotube porous framework in Example 4. This is because the carbon nanotube porous framework in Example 4 is prepared by directly mixing the carbon nanotube, the strong alkali reagent, the epoxy monomer, and the supercritical fluid solvent and the carbon nanotube porous framework in Example 1 is prepared by mixing the carbon nanotube, the supercritical fluid solvent, the strong alkali reagent, and the epoxy monomer successively. Test results of Examples 1 and 4 show that the successive addition of the reaction reagents according to the method of the present disclosure is conducive to improving the dispersion performance and electric conductivity of carbon nanotubes.

Lithium iron phosphate positive electrode sheets fabricated with the carbon nanotube porous frameworks in Comparative Examples 1 and 2 have resistivity values of 63 Ω·cm and 55.4 Ω·cm, respectively, indicating that the electric conductivity and dispersion performance of the carbon nanotube porous frameworks in Comparative Examples 1 and 2 are far worse than the electric conductivity and dispersion performance of the carbon nanotube porous framework prepared by the method of the present disclosure. This is because the polymer is directly mixed with the carbon nanotube, the supercritical fluid solvent, and the strong alkali reagent in Comparative Examples 1 and 2, such that, during a reaction, the polymer is difficult to enter the gaps among the agglomerated carbon nanotubes and only a small amount of the polymer enters the gaps among carbon nanotubes, which makes it difficult to disperse the carbon nanotubes and leads to a carbon nanotube porous framework with poor electric conductivity and dispersion performance. Because PVP is a common dispersing agent for carbon nanotubes and PVP exhibits a better dispersion effect for carbon nanotubes than for polypropylene oxide, the resistivity of a positive electrode sheet fabricated with the carbon nanotube porous framework in Comparative Example 1 is lower than the resistivity of a positive electrode sheet fabricated with the carbon nanotube porous framework in Comparative Example 2.

It can be known with reference to Comparative Example 3 that the preparation method of a carbon nanotube porous framework in the present disclosure can effectively improve the dispersion performance and electric conductivity of carbon nanotubes. In the traditional carbon nanotube dispersion method in Comparative Example 3, because carbon nanotubes need to be dispersed by a high-speed dispersing machine during a dispersion process, the dispersed carbon nanotubes are fractured and have a reduced length-to-diameter ratio, and the dispersed carbon nanotubes are difficult to form a continuous conductive network subsequently, resulting in reduced electric conductivity. The preparation method of a carbon nanotube porous framework in the present disclosure does not require a high-speed dispersing machine or a grinding machine to disperse carbon nanotubes, which allows the prominent dispersion of carbon nanotubes while retaining a high length-to-diameter ratio of carbon nanotubes. The preparation method of a carbon nanotube porous framework in the present disclosure solves the technical problem that it is difficult to disperse carbon nanotubes.
2. A supercapacitor was fabricated and tested for performance.

Polymethyl methacrylate (AC), a conductive agent, and PVDF were mixed according to a mass ratio of 92.5:3.5:4 to obtain a mixture, the mixture was prepared into a supercapacitor electrode sheet, and then the supercapacitor electrode sheet was fabricated into a supercapacitor.

With each of the carbon nanoporous frameworks prepared in Examples 1 to 5 and Comparative Examples 1 and 2, the carbon nanotube dispersion prepared in Comparative Example 3, and carbon black as a conductive agent, different supercapacitors were fabricated according to the above method, and then the performance of each supercapacitor was tested. Test results were recorded in Table 2.

TABLE 2

| | Example | Example | Example | Example | Example | Comparative | Comparative | Comparative | Carbon |
|---|---|---|---|---|---|---|---|---|---|
| Sample | 1 | 2 | 3 | 4 | 5 | Example 1 | Example 2 | Example 3 | black |
| Capacity (F) | 0.4619 | 0.4613 | 0.4601 | 0.4531 | 0.4520 | 0.2350 | 0.4436 | 0.4490 | 0.4495 |
| Specific capacity | 58.26 | 58.25 | 59.20 | 57.91 | 57.63 | 45.01 | 52.96 | 55.23 | 57.31 |
| (F/g) | | | | | | | | | |
| Direct-current | 5.26 | 5.24 | 5.23 | 5.38 | 6.0 | 22.31 | 18.36 | 27.52 | 9.00 |
| internal resistance | | | | | | | | | |
| (Ω) | | | | | | | | | |

3. A conductive plastic was prepared with the product of the present disclosure and tested for related properties.

The carbon nanotube porous framework prepared in Example 1 was mixed with a polycarbonate resin to obtain a mixture, where a mass of the carbon nanotube porous framework was 5% of a total mass of the mixture. Then the mixture was subjected to closed compounding for 10 min at a temperature of 250° C. and a rotational speed of 20 rpm and then subjected to injection molding to obtain a product. The properties of the product were tested. Data were recorded in Table 3.

TABLE 3

| | | | Test |
|---|---|---|---|
| Basic properties | Units | Test methods | results |
| Volume resistivity | Ω · cm | GB/T 1410 | 7 |
| Surface resistivity | Ω/sq | GB/T 1410 | 35 |
| Tensile strength | MPa | GB/T 1040.3-2006 | 63 |
| Yield strength | MPa | GB/T 1040.3-2006 | 63 |
| Tensile stain at break | % | GB/T 1040.3-2006 | 20 |
| Bending strength | MPa | GB/T 9341-2008 | 95.6 |
| Bending modulus | MPa | GB/T 9341-2008 | 2491 |
| Notched Izod impact | kJ/m2 | ASTM D256-2010 | 9.6 |
| strength (Izod) | | | |
| Flame resistance | class | UL94 | V2 |

The above examples are merely illustrative of some implementations of the present disclosure, and the description thereof is specific and detailed, but should not be construed as a limitation to the scope of the present disclosure. It should be noted that those of ordinary skill in the art can further make several variations and improvements without departing from the concept of the present disclosure, and these variations and improvements all fall within the protection scope of the present disclosure. Therefore, the protection scope of the present disclosure should be subject to the protection scope defined by the claims.

1. A carbon nanoporous framework, comprising a plurality of carbon nanounits, wherein the plurality of carbon nanounits are connected to form a three-dimensional network framework, there is a gap between adjacent two of the carbon nanounits, the carbon nanounits each comprise a carbon nanomaterial and a polymer wrapped around a surface of the carbon nanomaterial, and adjacent two of the carbon nanounits are interconnected by the polymer.

2. The carbon nanoporous framework according to claim 1, wherein a density of the carbon nanoporous framework is 0.01 g/cm³ to 0.3 g/cm³.

3. The carbon nanoporous framework according to claim 1, a specific surface area of the carbon nanoporous framework is 100 m²/g to 400 m²/g.

4. The carbon nanoporous framework according to claim 1, wherein a porosity of the carbon nanoporous framework is 50% to 98%.

5. The carbon nanoporous framework according to claim 1, wherein the carbon nanomaterial comprises at least one selected from the group consisting of a single-walled carbon nanotube, a multi-walled carbon nanotube, and graphene.

6. The carbon nanoporous framework according to claim 1, wherein a ratio of a total mass of the plurality of carbon nanounits to a mass of the polymer is (5-15):(1-3).

7. The carbon nanoporous framework according to claim 1, wherein the polymer comprises an epoxy polymer.

8. The carbon nanoporous framework according to claim 7, wherein the epoxy polymer comprises at least one selected from the group consisting of polypropylene oxide, ethylene oxide-propylene oxide copolyether, and polyethylene oxide.

9. A method for preparing a carbon nanoporous framework through supercritical fluid-assisted in-situ polymerization, comprising the following steps:
subjecting a carbon nanomaterial, a strong alkali reagent, an epoxy monomer, and a supercritical fluid solvent to a mixing treatment until the strong alkali reagent fully reacts with the epoxy monomer, wherein a pressure and a temperature for the mixing treatment keep the supercritical fluid solvent in a supercritical fluid state; and
releasing the pressure to one standard atmosphere to obtain the carbon nanoporous framework.

10. The method for preparing a carbon nanoporous framework through supercritical fluid-assisted in-situ polymerization according to claim 9, wherein during the mixing treatment, substances are added as follows:
the carbon nanomaterial is first mixed with the supercritical fluid solvent, then the strong alkali reagent is added to allow a first reaction, and then the epoxy monomer is added to allow a second reaction.

11. The method for preparing a carbon nanoporous framework through supercritical fluid-assisted in-situ polymerization according to claim 9 or 10, wherein the carbon nanomaterial, the strong alkali reagent, the epoxy monomer, and the supercritical fluid solvent are in a mass ratio of (5-15):(0.05-0.2):(1-3):(5-15).

12. The method for preparing a carbon nanoporous framework through supercritical fluid-assisted in-situ polymerization according to claim 9, wherein the strong alkali reagent comprises at least one selected from the group consisting of sodium ethoxide, potassium ethoxide, sodium hydroxide, and potassium hydroxide.

13. (canceled)

14. The method for preparing a carbon nanoporous framework through supercritical fluid-assisted in-situ polymerization according to claim 9, wherein the epoxy monomer comprises at least one selected from the group consisting of propylene oxide, ethylene oxide, and butylene oxide.

15. (canceled)

16. (canceled)

17. The method for preparing a carbon nanoporous framework through supercritical fluid-assisted in-situ polymerization according to claim 9, wherein the carbon nanomaterial comprises at least one selected from the group consisting of a single-walled carbon nanotube, a multi-walled carbon nanotube, and graphene.

18. The method for preparing a carbon nanoporous framework through supercritical fluid-assisted in-situ polymerization according to claim 9, wherein the supercritical fluid solvent comprises at least one selected from the group consisting of a supercritical carbon dioxide solvent, a supercritical ethanol solvent, and a supercritical propanol solvent.

19. The method for preparing a carbon nanoporous framework through supercritical fluid-assisted in-situ polymerization according to claim 18, wherein the supercritical fluid solvent comprises the supercritical carbon dioxide solvent.

20. The method for preparing a carbon nanoporous framework through supercritical fluid-assisted in-situ polymerization according to claim 9, wherein during the mixing treatment, the pressure is 7 MPa to 25 MPa;
wherein during the mixing treatment, the temperature is 80° C. to 100° C.; and
wherein the mixing treatment is conducted for 3 hrs to 5 hrs.

21. (canceled)

22. (canceled)

23. The method for preparing a carbon nanoporous framework through supercritical fluid-assisted in-situ polymerization according to claim 9, wherein the pressure is released within 0.1 s.

24. The method for preparing a carbon nanoporous framework through supercritical fluid-assisted in-situ polymerization according to claim 9, wherein the mixing treatment further comprises: adding an organic co-solvent to the carbon nanomaterial, the strong alkali reagent, the epoxy monomer, and the supercritical fluid solvent.

25. The method for preparing a carbon nanoporous framework through supercritical fluid-assisted in-situ polymerization according to claim 24, wherein the organic co-solvent comprises methanol.

26. (canceled)
